(19) United States
(12) Patent Application Publication
(10) Pub. No.: US 2025/0372916 A1
(43) Pub. Date: Dec. 4, 2025

(54) COMBINED CONNECTOR

(71) Applicant: P-TWO INDUSTRIES INC., Taoyuan City (TW)

(72) Inventors: Jo-Ming Fan, Taoyuan City (TW); Chih-Wei Huang, Taoyuan City (TW)

(21) Appl. No.: 19/093,536

(22) Filed: Mar. 28, 2025

(30) Foreign Application Priority Data
May 30, 2024 (TW) 113205625

(51) Int. Cl. H01R 13/514

(52) U.S. Cl. CPC H01R 13/514

(57) ABSTRACT

A combined connector is disclosed, which comprises an insulating housing, a plurality of contacts held by the insulating housing, the insulating housing including a mating portion mateable with a mating connector in a first direction, the insulating housing further including a first lateral surface and a second lateral surface opposite to each other in a second direction, the second direction being perpendicular to the first direction, the insulating housing being formed with a dovetail rail portion on one of the first and second lateral surfaces and a dovetail socket portion on the other of the first and second lateral surfaces. The dovetail rail portion and the dovetail socket portion extend in a third direction perpendicular to the first and second directions. Therefore, the combined connector can be slidably engaged with another combined connector in the third direction by means of the dovetail rail portion or the dovetail socket portion.

### CROSS-REFERENCES TO RELATED APPLICATIONS

This application claims the benefit of priority to Taiwanese Patent Application No. 113205625 filed on May 30, 2024, which is hereby incorporated by reference in its entirety.

### BACKGROUND OF THE INVENTION

### Field of the Invention

The present invention relates to a connector, and in particular to a combined connector.

### Descriptions of the Related Art

In Taiwanese Utility Model Patent No. M599037 (hereinafter referred to as “Patent Document 1”), a combined connector having a dovetail structure is disclosed, which can be combined with another combined connector via the dovetail structure. In Patent Document 1, the dovetail structure is oriented in parallel to the mating direction of the mating connector.

However, in the application of a horizontal type connector, in the case that the assembly space is limited, it is desirable that the combined connector is assembled or dissembled in a direction perpendicular to the mating direction of the mating connector. The combined connector disclosed in Patent Document 1 cannot meet this demand.

### SUMMARY OF THE INVENTION

One object of the present invention is to provide a combined connector which allows two or more combined connectors to be combined together.

Another object of the present invention is to provide a combined connector of which the engaging direction of another combined connector is perpendicular to the mating direction of the mating connector.

According to one aspect of the present invention, a combined connector is provided, the combined connector comprising an insulating housing and a plurality of contacts held by the insulating housing, the insulating housing including a mating portion mateable with a mating connector in a first direction, the insulating housing further including a first lateral surface and a second lateral surface opposite to each other in a second direction, the second direction being perpendicular to the first direction, the insulating housing being formed with a dovetail rail portion on one of the first and second lateral surfaces, and a dovetail socket portion on the other of the first and second lateral surfaces, wherein the dovetail rail portion and the dovetail socket portion extend in a third direction perpendicular to the first and second directions, and the combined connector is capable of being slidably engaged with another combined connector in the third direction through the dovetail rail portion or the dovetail socket portion.

According to the combined connector of the present invention, the plurality of contacts include a plurality of signal contacts.

According to the combined connector of the present invention, the plurality of contacts include a plurality of power source contacts.

According to the combined connector of the present invention, the plurality of contacts include a plurality of signal contacts and a plurality of power source contacts.

According to the combined connector of the present invention, the dovetail rail portion includes a first rail section and a section rail section, the first rail portion has an outer edge interval smaller than an outer edge interval of the second rail portion, the dovetail socket portion includes a first socket section and a second socket section, and the first socket section has an inner edge interval small than an inner edge interval of the second socket section.

According to the combined connector of the present invention, the outer edge interval of the first rail section is greater than the inner edge interval of the second socket section.

According to the combined connector of the present invention, the dovetail rail portion is provided with a first stopper protrusion in the second rail section, the dovetail socket portion is provided with a second stopper protrusion, corresponding to the first stopper protrusion, in the second socket section.

According to the combined connector of the present invention, the insulating housing is formed with a deformation slot adjacent to the first stopper protrusion, and the deformation slot allows the first stopper protrusion to be deformed or displaced inwardly in the second direction when the first stopper protrusion is pressed.

According to the combined connector of the present invention, a slidably engaging surface of the dovetail rail portion in the second rail section is formed with a first tight fitting rib and a second tight fitting rib, and the first tight fitting rib and the second tight fitting rib extend in the third direction.

According to the combined connector of the present invention, a slidably engaging surface of the dovetail socket portion in the first socket section is formed with a third tight fitting rib and a fourth tight fitting rib, and the third tight fitting rib and the fourth tight fitting rib extend in the third direction.

The above and other objects and advantages of the present invention will become apparent from the accompanying drawings and the following detailed description.

### BRIEF DESCRIPTION OF THE DRAWINGS

FIG. 1 is a perspective view of a connector assembly according to the embodiment of the present invention, wherein the connector assembly is composed of two combined connectors.

FIG. 2 is a perspective view of the combined connector according to the embodiment of the present invention.

FIG. 3 is another perspective view of the combined connector according to the embodiment of the present invention.

FIG. 4 is a side view of the combined connector according to the embodiment of the present invention.

FIG. 5 is another side view of the combined connector according to the embodiment of the present invention.

FIG. 6 is a sectional view taken along the line AA in FIG. 4.

FIG. 7 is a sectional view taken along the line BB in FIG. 5.

FIG. 8 is a front view of the combined connector according to the embodiment of the present invention.

FIG. 9 is a sectional view taken along the line CC in FIG. 5.

FIG. 10 is a bottom view of the combined connector according to the embodiment of the present invention.

### DETAILED DESCRIPTION OF THE PREFERRED EMBODIMENT

The combined connector according to the embodiment of the present invention will be described with reference to the drawings. In the drawings, the same components or components with similar functions are designated by the same reference numerals. The drawings are not necessarily drawn to scale.

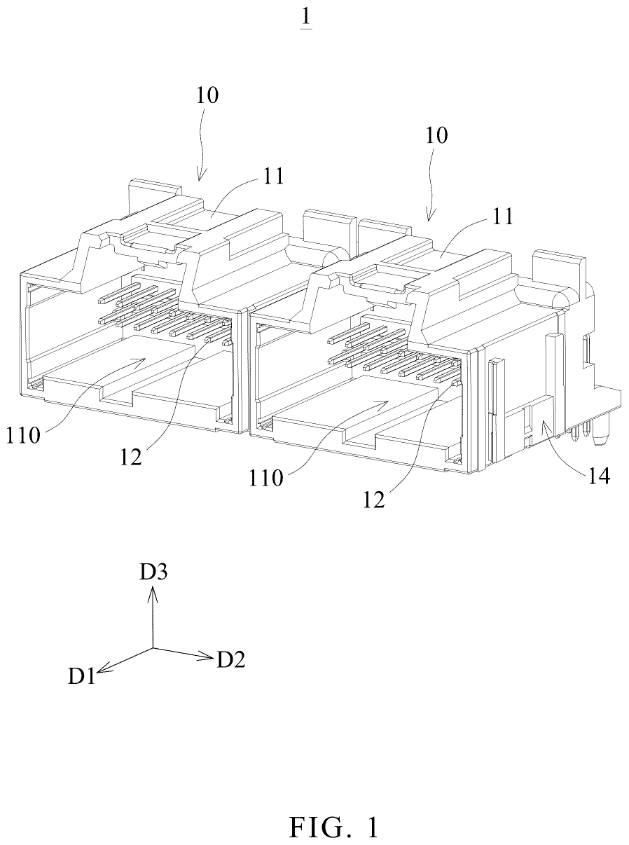

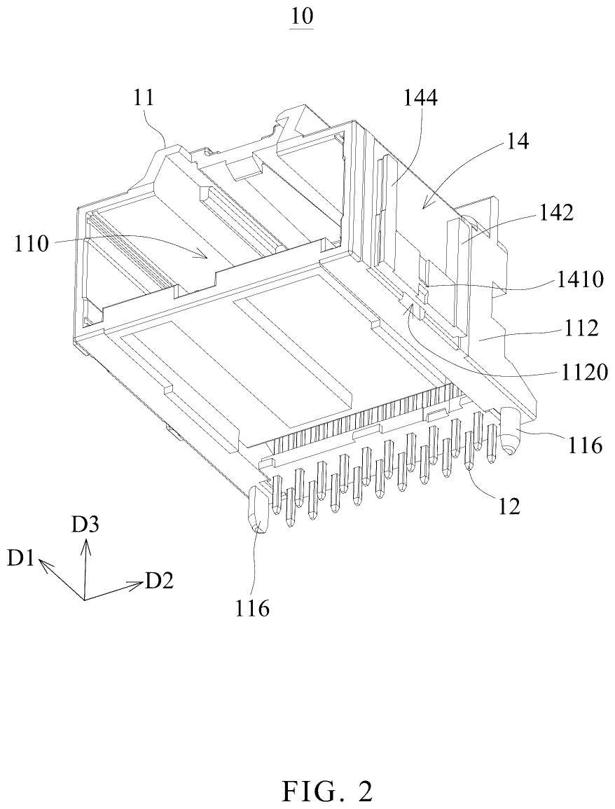

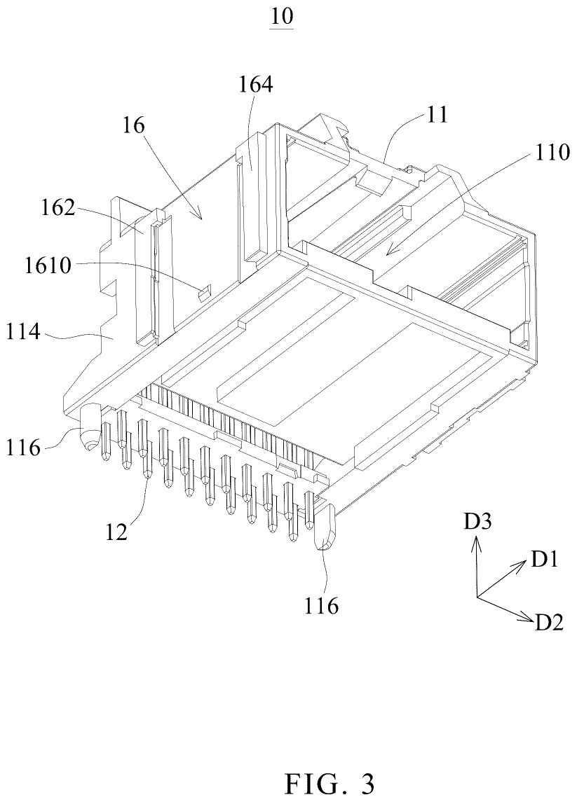

FIG. 1 is a perspective view of the connector assembly according to the embodiment of the present invention. The connector assembly is entirely designated by the reference numeral 1. The connector assembly 1 is composed of two combined connectors 10. The combined connector 10 is described with reference to FIGS. 2 and 3, wherein FIG. 2 is a perspective view of the combined connector according to the embodiment of the present invention, and FIG. 3 is another perspective view of the combined connector according to the embodiment of the present invention. In this embodiment, the combined connector 10 is formed into a horizontal type connector, but the present invention is not limited thereto. If necessary, the combined connector 10 can be formed into a vertical type connector.

The combined connector 10 comprises an insulating housing 11 and a plurality of contacts 12 held by the insulating housing 11. The insulating housing 11 is made of insulating resin or polymer material by injection molding. The insulating housing 11 has a fitting opening 110 as a mating portion into which a mating connector (not shown) can be inserted in a first direction D1 (a fitting direction). Two positioning posts 116 are formed on the bottom surface of the insulating housing 11 for temporarily positioning the connector assembly 1 on the circuit board before the connector assembly 1 is soldered to the circuit board. The contacts 12 are made of copper or copper alloy. The contacts 12 are arranged in two rows along the second direction D2 (a width direction) perpendicular to the first direction D1. The contact portion of the contact 12 is positioned in the fitting opening 110 so as to be in electrical contact with the contact of the mating connector when the mating connector is inserted into the fitting opening 110. The contacts 12 may include only signal contacts or only power source contacts. Alternatively, the contacts 12 may include signal contacts and power source contacts.

As shown in FIGS. 2 and 3, the insulating housing 11 includes a first lateral surface 112 and a second lateral surface 114 opposite to each other in the second direction D2. A dovetail rail portion 14 and a dovetail socket portion 16 are formed on the first lateral surface 112 and the second lateral surface 114, respectively. The dovetail rail portion 14 and the dovetail socket portion 16 extend in a third direction D3 (a height direction) perpendicular to the first direction D1 and the second direction D2. The dovetail socket portion 16 of one combined connector 10 can be slidably engaged with the dovetail rail portion 14 of another combined connector 10 in the third direction D3. In this way, the two combined connectors 10 are combined into the connector assembly 1.

The dovetail rail 14 includes a first rail 142 and a second rail 144 arranged in parallel. The dovetail rail portion 14 further includes a first stopper protrusion 1410 formed between the first rail 142 and the second rail 144 and adjacent to the lower edge of the combined connector 10. The first stopper protrusion 1410 is formed into a wedge-shaped stopper protrusion with a slope. The insulating housing 11 is formed with a deformation slot 1120 adjacent to the first stopper protrusion 1410. Specifically, the deformation slot 1120 is formed in the wall where the first stopper protrusion 1410 is formed and formed at the inner side with respect to the first stopper protrusion 1410 in the second direction D2. The deformation slot 1120 allows the first stopper protrusion 1410 to be deformed or displaced inwardly in the second direction D2 when the first stopper protrusion is pressed.

The dovetail socket portion 16 includes a first socket wall 162 and a second socket wall 164 arranged in parallel. The first socket wall 162 and the second socket wall 164 define a socket to be slidably engaged with the first rail 142 and the second rail 144. The dovetail socket portion 16 further includes a second stopper protrusion 1610 formed between the first socket wall 162 and the second socket wall 164 and corresponding to the first stopper protrusion 1410. During a process that the dovetail rail portion 14 of one combined connector 10 is slidably engaged with the dovetail socket portion 16 of another combined connector 10, the first stopper protrusion 1410 is pressed by the second stopper protrusion 1610 and deformed or displaced inwardly in the second direction D2, allowing the second stopper protrusion 1610 to run over the first stopper protrusion 1410. After that, the first stopper protrusion 1410 and the second stopper protrusion 1610 prevent the two connectors 10 combined with each other from moving with respect to each other in the third direction D3.

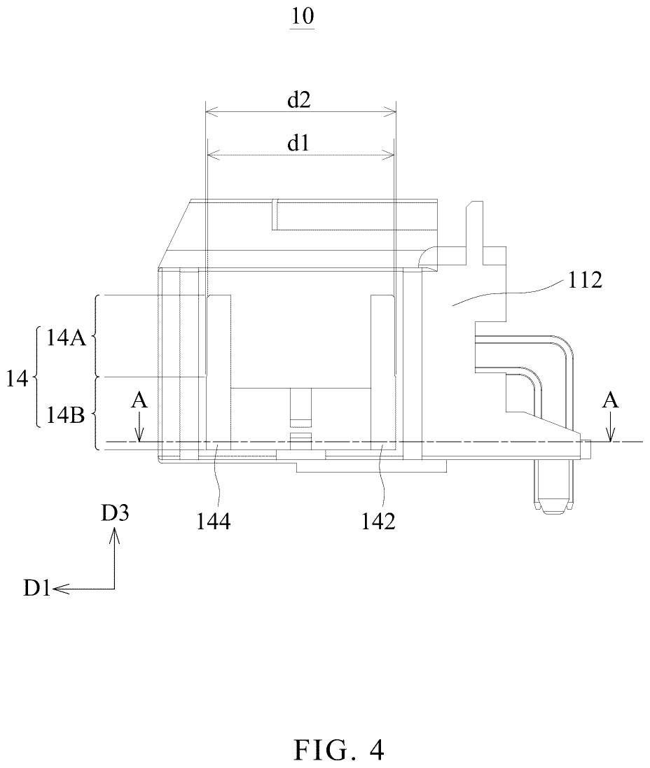

FIG. 4 is a side view of the combined connector 10, showing the dovetail rail portion 14. As shown in FIG. 4, the dovetail rail portion 14 is composed of a first rail section 14A and a second rail section 14B. The outer edge interval d1 of the first rail section 14A of the dovetail rail portion 14 is smaller than the outer edge interval d2 of the second rail section 14B of the dovetail rail portion 14.

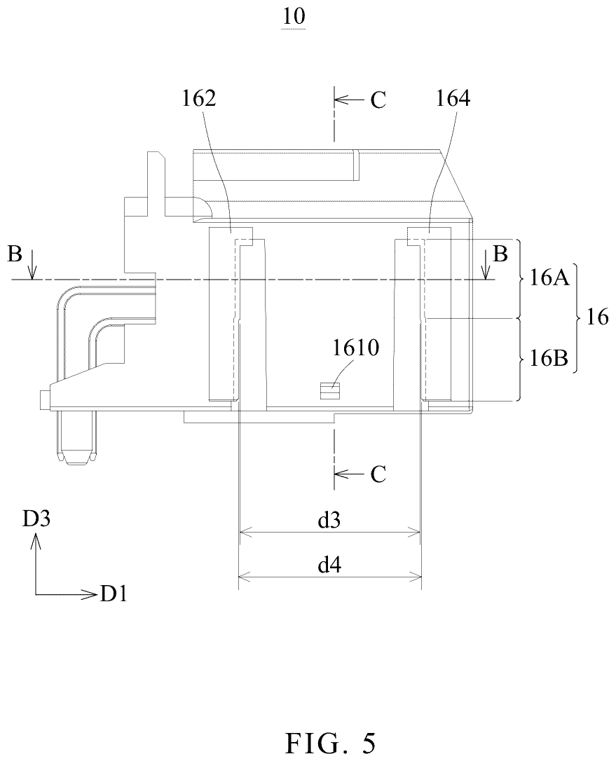

FIG. 5 is another side view of the combined connector 10, showing the dovetail socket portion 16. As shown in FIG. 5, the dovetail socket portion 16 is composed of a first socket section 16A and a second socket section 16B. The inner edge interval d3 of the first socket section 16A of the dovetail socket portion 16 is smaller than the inner edge interval d4 of the second socket section 16B of the dovetail socket portion 16. The outer edge interval d1 is set to be larger than the inner edge interval d4 so as to prevent the dovetail rail portion 14 and the dovetail socket portion 16 slidably engaged with each other from being separated from each other in the second direction D2.

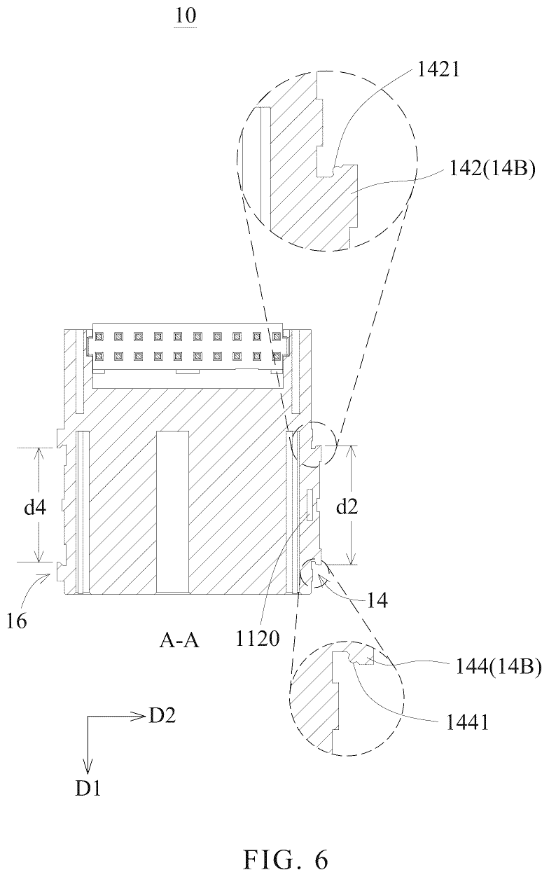

FIG. 6 is a sectional view taken along the line AA in FIG. 4. In the second rail section 14B with a wider outer edge interval (d2), a slidably engaging surface of the dovetail rail portion 14 is formed with a first tight fitting rib and a second tight fitting rib. Specifically, in the second rail section 14B, the slidably engaging surface of the first guide 142 is formed with a first tight fitting rib 1421, and the slidably engaging surface of the second rail 144 is formed with a second tight fitting rib 1441. The first tight fitting rib 1421 and the second tight fitting rib 1441 extend in the third direction D3. The first tight fitting rib 1421 and the second tight fitting rib 1441 have the same structure and size.

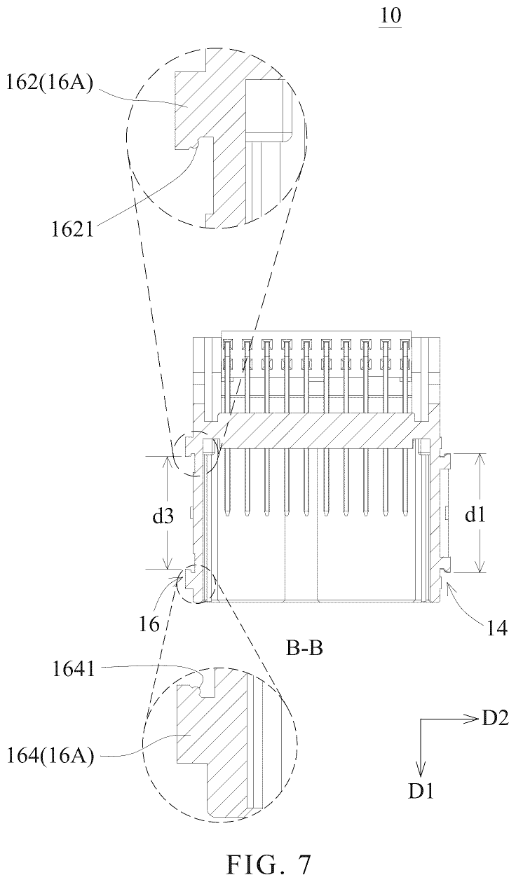

FIG. 7 is a sectional view taken along the line BB in FIG. 5. In the first socket section 16A with a narrow inner edge interval (d3), a slidably engaging surface of the dovetail socket portion 16 is formed with a third tight fitting rib and a fourth tight fitting rib. Specifically, in the first socket section 16A, the slidably engaging surface of the first socket wall 162 is formed with a third tight fitting rib 1621, and the slidably engaging surface of the second socket wall 164 is formed with a fourth tight fitting rib 1641. The third tight fitting rib 1621 and the fourth tight fitting rib 1641 extend in the third direction D3. The third tight fitting rib 1621 and the fourth tight fitting rib 1641 have the same structure and size.

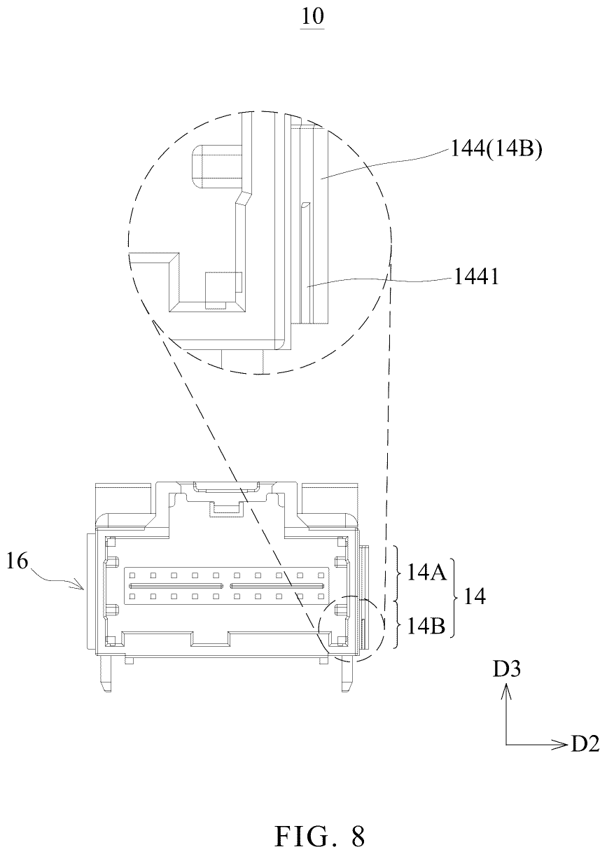

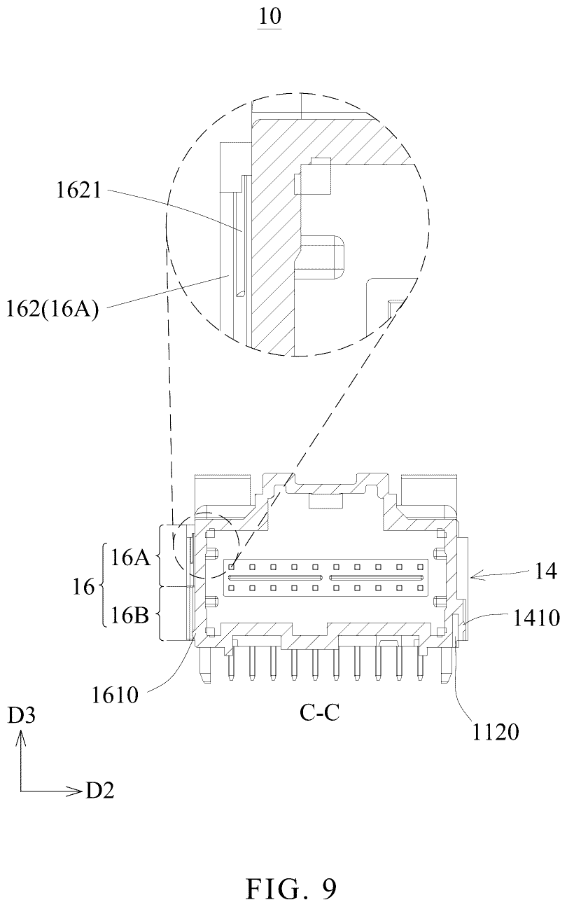

FIG. 8 is a front view of the combined connector 10. As shown in FIG. 8, the second tight fitting rib 1441 extends for a certain distance in the third direction D3. FIG. 9 is a sectional view taken along the line CC in FIG. 5. As shown in FIG. 9, the third tight fitting rib 1621 extends for a certain distance along the third direction D3.

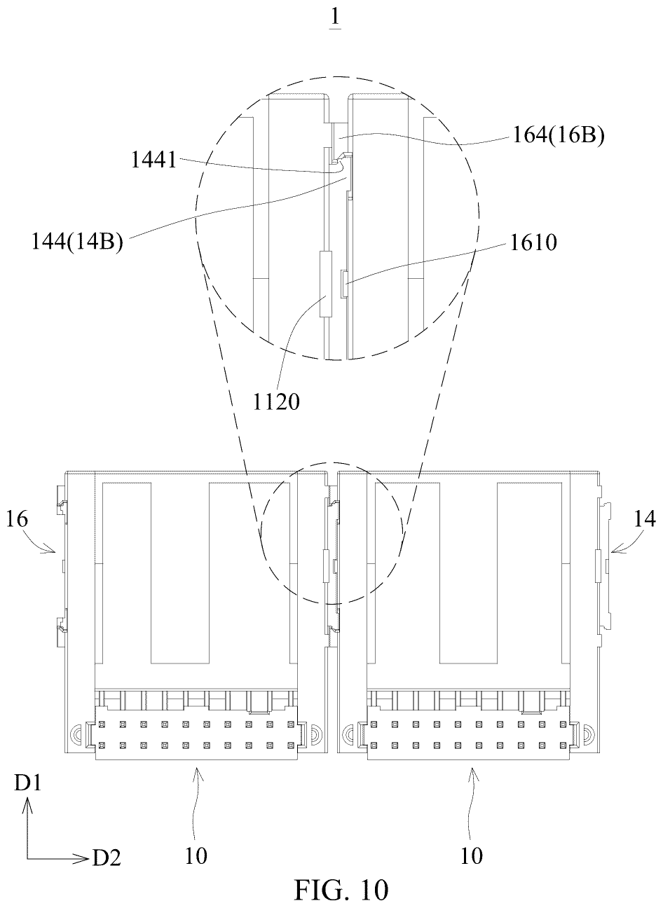

FIG. 10 is a bottom view of the connector assembly 1. As shown in FIG. 10, the dovetail rail portion of the combined connector 10 on the left hand side is engaged with the dovetail socket portion of the combined connector 10 on the right hand side. By means of the first and second tight fitting ribs, the second rail section 14B can be engaged with the second socket section 16B in a tightly fitting manner. By means of the third and fourth tight fitting ribs, the first rail section 14A can be engaged with the first socket section 16A in a tightly fitting manner. Therefore, loosening of the engagement between the dovetail rail portion 14 and the dovetail socket portion 16 can be prevented.

In the connector assembly 1, the dovetail rail portion 14 or the dovetail socket portion 16 which is unused can be combined with a further combined connector.

It should be understood that according to the present invention, the connector assembly is not limited to being composed of the same combined connectors. The connector assembly can also be composed of two different combined connectors. For example, the color of the insulating housing of one combined connector may be different from the color of the insulating housing of another combined connector. Alternatively, the shape of the fitting opening of the insulating housing of one combined connector may be different from the shape of the fitting opening of the insulating housing of another combined connector. Alternatively, the layout or type of the contacts of one combined connector may be different from the layout or type of the contacts of another combined connector. The number of the combined connectors constituting the connector assembly is not limited to two. The connector assembly can be composed of three or more combined connectors.

While this invention has been described in reference to preferred embodiments, it should be understood that numerous changes and modifications could be made within the spirit and scope of the inventive concepts described. Accordingly, it is intended that the invention not be limited to the disclosed embodiment, but that it have the full scope permitted by the language of the following claims.

What is claimed is:

1. A combined connector comprising an insulating housing and a plurality of contacts held by the insulating housing, the insulating housing including a mating portion mateable with a mating connector in a first direction, the insulating housing further including a first lateral surface and a second lateral surface opposite to each other in a second direction, the second direction being perpendicular to the first direction, the insulating housing being formed with a dovetail rail portion on one of the first and second lateral surfaces, and a dovetail socket portion on the other of the first and second lateral surfaces,
wherein the dovetail rail portion and the dovetail socket portion extend in a third direction perpendicular to the first and second directions, and the combined connector is capable of being slidably engaged with another combined connector in the third direction through the dovetail rail portion or the dovetail socket portion.

2. The combined connector of claim 1, wherein the plurality of contacts include a plurality of signal contacts.

3. The combined connector of claim 1, wherein the plurality of contacts include a plurality of power source contacts.

4. The combined connector of claim 1, wherein the plurality of contacts include a plurality of signal contacts and a plurality of power source contacts.

5. The combined connector of claim 1, wherein the dovetail rail portion includes a first rail section and a section rail section, the first rail section has an outer edge interval smaller than an outer edge interval of the second rail section, the dovetail socket portion includes a first socket section and a second socket section, and the first socket section has an inner edge interval small than an inner edge interval of the second socket section.

6. The combined connector of claim 5, wherein the inner edge interval of the first socket section is smaller than the outer edge interval of the first rail section, and the inner edge interval of the second socket section is smaller than the outer edge interval of the second rail section./wherein the outer edge interval of the first rail section is greater than the inner edge interval of the second socket section.

7. The combined connector of claim 5, wherein the dovetail rail portion is provided with a first stopper protrusion in the second rail section, the dovetail socket portion is provided with a second stopper protrusion, corresponding to the first stopper protrusion, in the second socket section.

8. The combined connector of claim 7, wherein the insulating housing is formed with a deformation slot adjacent to the first stopper protrusion, and the deformation slot allows the first stopper protrusion to be deformed or displaced inwardly in the second direction when the first stopper protrusion is pressed.

9. The combined connector of claim 5, wherein in the second rail section, a slidably engaging surface of the dovetail rail portion is formed with a first tight fitting rib and a second tight fitting rib, and the first tight fitting rib and the second tight fitting rib extend in the third direction.

10. The combined connector of claim 5, wherein in the first socket section, a slidably engaging surface of the dovetail socket portion is formed with a third tight fitting rib and a fourth tight fitting rib, and the third tight fitting rib and the fourth tight fitting rib extend in the third direction.
